(19) United States
(12) Patent Application Publication
(10) Pub. No.: US 2020/0380279 A1
(43) Pub. Date: Dec. 3, 2020

(54) METHOD AND APPARATUS FOR LIVENESS DETECTION, ELECTRONIC DEVICE, AND STORAGE MEDIUM

(71) Applicant: BEIJING SENSETIME TECHNOLOGY DEVELOPMENT CO., LTD, Beijing (CN)

(72) Inventors: Guowei YANG, Beijing (CN); Jing SHAO, Beijing (CN); Junjie YAN, Beijing (CN); Xiaogang WANG, Beijing (CN)

(21) Appl. No.: 16/998,279

(22) Filed: Aug. 20, 2020

Related U.S. Application Data
(63) Continuation of application No. PCT/CN2019/120404, filed on Nov. 22, 2019.

(30) Foreign Application Priority Data
Apr. 1, 2019 (CN) 201910257350.9

(51) Int. Cl. G06K 9/00; G06N 3/08; G06F 17/18

(52) U.S. Cl. CPC G06K 9/00906; G06F 17/18; G06N 3/08; G06K 9/00228

(57) ABSTRACT

A method and apparatus for liveness detection includes: processing a target image to obtain probabilities of multiple pixel points of the target image to be corresponding to spoofing; determining a predicted face region in the target image; and obtaining, based on the probabilities of the multiple pixel points of the target image to be corresponding to spoofing and the predicted face region, a liveness detection result of the target image.

### CROSS-REFERENCE TO RELATED APPLICATIONS

This application is a continuation of International Application No. PCT/CN2019/120404, filed on Nov. 22, 2019, which claims priority to Chinese Patent Application No. 201910257350.9, filed on Apr. 1, 2019. The disclosures of International Application No. PCT/CN2019/120404 and Chinese Patent Application No. 201910257350.9 are hereby incorporated by reference in their entireties.

### BACKGROUND

Face recognition technologies are widely applied to scenarios such as face unlocking, face payment, identity authentication, and video surveillance. However, a face recognition system has the risk of being easily deceived by spoofing such as pictures and videos with faces as well as masks. In order to ensure the security of a face recognition system, a liveness detection technology is needed to confirm the authenticity of a face entered into the system, i.e., to determine whether submitted biometric features are from a living individual.

At present, a time duration required for a single liveness detection using a face recognition method based on the face movement is too long, thus reducing the overall efficiency of the face recognition system. Additional hardware facilities such as a multi-ocular camera or a 3D structured optical device are usually introduced in the recognition and detection methods based on single image frames, thus increasing the deployment costs and reducing the applicability. How to improve the accuracy of liveness detection of a single image frame is a technical problem to be solved urgently in this field.

### SUMMARY

The disclosure relates to, but is not limited to, the field of computer vision technologies, and specifically relates to a method and apparatus for liveness detection, an electronic device, and a storage medium.

Embodiments of the disclosure provide a method and apparatus for liveness detection, an electronic device, and a storage medium.

A first aspect of the embodiments of the disclosure provides a method for liveness detection, including: processing a target image to obtain probabilities of multiple pixel points of the target image to be corresponding to spoofing; determining a predicted face region in the target image; and obtaining, based on the probabilities of the multiple pixel points of the target image to be corresponding to spoofing and the predicted face region, a liveness detection result of the target image.

A second aspect of the embodiments of the disclosure provides an apparatus for liveness detection, including a memory storing processor-executable instructions; and a processor arranged to execute the stored processor-executable instructions to perform operations of: processing a target image to obtain probabilities of multiple pixel points of the target image to be corresponding to spoofing; determining a predicted face region in the target image; and obtaining, based on the probabilities of the multiple pixel points of the target image to be corresponding to spoofing and the predicted face region, a liveness detection result of the target image.

A third aspect of the embodiments of the disclosure provides a non-transitory computer-readable storage medium, having stored thereon computer program instructions that, when executed by a computer, cause the computer to perform the following: processing a target image to obtain probabilities of multiple pixel points of the target image to be corresponding to spoofing; determining a predicted face region in the target image; and obtaining, based on the probabilities of the multiple pixel points of the target image to be corresponding to spoofing and the predicted face region, a liveness detection result of the target image.

### BRIEF DESCRIPTION OF THE DRAWINGS

The accompanying drawings herein incorporated in the description and constituting a part of the description describe the embodiments of the present disclosure and are intended to explain the technical solutions of the present disclosure together with the description.

FIG. 1 is a schematic flowchart of a method for liveness detection disclosed in embodiments of the disclosure.

FIG. 2 is a schematic flowchart of another method for liveness detection disclosed in embodiments of the disclosure.

FIG. 3 is a schematic diagram of a processing process of a neural network disclosed in embodiments of the disclosure.

FIG. 4 is a schematic structural diagram of an apparatus for liveness detection disclosed in embodiments of the disclosure.

FIG. 5 is a schematic structural diagram of an electronic device disclosed in embodiments of the disclosure.

### DETAILED DESCRIPTION

The technical solutions in embodiments of the disclosure are clearly and fully described below with reference to the accompanying drawings in the embodiments of the disclosure. Apparently, the described embodiments are merely some of the embodiments of the disclosure, but not all the embodiments. Based on the embodiments of the disclosure, all other embodiments obtained by a person of ordinary skill in the art without involving an inventive effort shall fall within the scope of protection of the disclosure.

The term “and/or” in the disclosure describes only an association relationship describing associated objects and indicates that three relationships may exist. For example, A and/or B can indicate the following three cases: only A exists, both A and B exist, and only B exists. In addition, the term “at least one” herein indicates any one of multiple elements or any combination of at least two of multiple elements. For example, including at least one of A, B, or C can indicate including any one or more elements selected from a set consisting of A, B, and C. The terms “first”, “second”, and the like in the description, the claims, and the accompanying drawings in the disclosure are used for distinguishing different objects, rather than describing specific sequences. In addition, the terms “include” and “have” and any deformation thereof aim at covering non-exclusive inclusion. For example, a process, a method, a system, a product, or a device including a series of operations or units is not limited to the listed operations or units, but also optionally includes operations or units that are not listed or other operations or units inherent to the process, method, product, or device.

Reference herein to “embodiments” means that a particular feature, structure, or characteristic described in combination with the embodiments may be included in at least one embodiment of the disclosure. The appearances of this phrase in various places in the description do not necessarily all refer to the same embodiment, or separate or alternative embodiments mutually exclusive of other embodiments. The embodiments described herein, explicitly and implicitly understood by a person skilled in the art, may be combined with other embodiments.

An apparatus for liveness detection related in the embodiments of the disclosure is an apparatus capable of performing liveness detection which may be an electronic device, where the electronic device includes a terminal device. In a specific implementation, the terminal device includes, but is not limited to, portable devices such as a mobile phone, a laptop computer, or a tablet computer having a touch sensitive surface (such as a touch screen display and/or a touch panel). It should also be understood that in some embodiments, the device is a desktop computer having a touch sensitive surface (such as a touch screen display and/or a touch panel), instead of a portable communication device.

The concept of deep learning in the embodiments of the disclosure stems from researches of artificial neural networks. A multilayer perceptron including multiple hidden layers is a deep learning structure. In deep learning, low-level features are combined to form a more abstract high-level representation attribute category or feature to discover distributed feature representation of data.

Deep learning is a method based on representation learning performed on data in machine learning. Observed values (such as an image) may be represented in a variety of ways, such as a vector of an intensity value of each pixel point, or more abstractly represented as a series of edges, regions of particular shapes, etc. It is easier to learn tasks (for example, face recognition or facial expression recognition) from examples using some specific representation methods. The benefit of deep learning is to replace manual feature acquisition with unsupervised or semi-supervised feature learning and hierarchical feature extraction efficient algorithms Deep learning is a new field in machine learning research, and has a motivation of creating a neural network, which imitates a mechanism of a human brain to interpret data such as an image, sound, and text, for performing analysis and learning by simulating the human brain.

Similar to a machine learning method, a deep machine learning method also includes supervised learning and unsupervised learning. Learning models created under different learning frameworks are much different. For example, a Convolutional Neural Network (CNN) is a machine learning model based on deep supervised learning, which may also be called a network structure model based on deep learning, falls within a category of feed forward neural networks including convolutional calculation and having deep structures, and is one of representative algorithms of deep learning. A Deep Belief Net (DBN) is a machine learning model based on unsupervised learning.

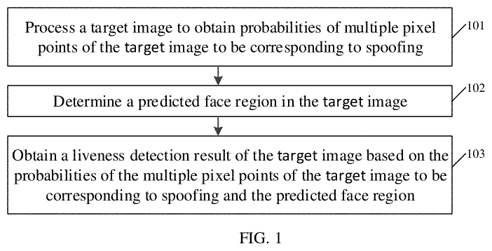

The following describes the embodiments of the disclosure in detail. Referring to FIG. 1, FIG. 1 is a schematic flowchart of a method for liveness detection disclosed in the embodiments of the disclosure. As shown in FIG. 1, the method for liveness detection includes the following operations.

At 101, a target image is processed to obtain probabilities of multiple pixel points of the target image to be corresponding to spoofing. Liveness detection is a method for determining true physiological features of an object in some identity verification scenarios. Generally, in face recognition applications, liveness detection can verify whether a user performing an operation is a real living person using technologies such as face key point positioning and face tracking by means of combined actions such as blinking, opening the mouth, shaking the head, and nodding, so that common attack means by, such as, photos, face swapping, masks, blocking, and images recaptured from screens can be resisted, thus facilitating identifying fraud behaviors and protecting interests of users.

In the embodiments of the disclosure, the method for liveness detection may be applied to various scenarios that need face application. For example, the method for liveness detection may be applied to the security field. When a security device in the security field performs face verification for security, whether a currently acquired image is an image acquired from a living person can be determined by the method for liveness detection provided in the embodiments of the disclosure.

For example, upon acquiring a face image or receiving a face image from other acquisition devices, an access control device in the security field performs spoofing verification by using the method provided in the embodiments of the disclosure, if the spoofing verification is passed, determines that the currently acquired image is acquired from a real living person, and performs security verification in combination with other biometric verification technologies such as face verification and/or iris verification. On the one hand, the accuracy of a biometric result is ensured so as to ensure security in the security field. By means of the method provided in the embodiments of the disclosure, pixel-level spoofing verification may be performed based on a single image, etc., thereby quickly completing spoofing verification, improving the verification rate, and reducing time delay.

For another example, during payment by a terminal device such as a mobile terminal, in order to ensure the security of payment, payment verification may be performed in combination with biometric features. However, in order to reduce the probability of passing biometric verification by using spoofing, a mobile terminal and the like also performs spoofing verification in the embodiments of the disclosure. The mobile terminal may autonomously perform spoofing verification of the disclosure after acquiring an image, so as to reduce the risk of counterfeiting by spoofing. On the other hand, using the spoofing verification method provided by the embodiments of the disclosure for spoofing verification has the characteristics of fewer images to be acquired and high verification speed.

As mentioned above, the time duration required for a single detection by such a method for liveness detection based on face movement is relatively long, thus reducing the overall efficiency of a face recognition system.

An execution subject of the method for liveness detection may be the apparatus for liveness detection. For example, the method for liveness detection may be performed by a terminal device or a server or other processing devices, where the terminal device may be a User Equipment (UE), a mobile device, a user terminal, a terminal, a cellular phone, a cordless phone, a Personal Digital Assistant (PDA), a handheld device, a computing device, a vehicle-mounted device, a wearable device, etc. In some possible implementations, the method for liveness detection may be implemented by invoking, by a processor, computer-readable instructions stored in a memory.

The embodiments of the disclosure can mainly solve the technical problem of liveness detection for a single image frame. The aforementioned target image may be a single image frame, and may be an image acquired by a camera, such as a photo captured by a camera of a terminal device or a single image frame in a video recorded by a camera of a terminal device. No limitation is made to the acquisition manner of the target image and to specific implementations of examples in the embodiments of the disclosure.

The single image frame mentioned in the embodiments of the disclosure is a still picture. An animation effect, such as a TV video, can be formed by consecutive frames. Generally speaking, the number of frames is simply the number of frames of pictures transmitted in 1 second, may also be understood as the number of times a graphics processing unit can perform refreshing per second, and are usually expressed in fps (Frames Per Second). Smooth and realistic animation can be obtained with a high frame rate.

In a possible implementation, the target image may be input to a neural network for processing so as to output a probability of each pixel point of the target image to be corresponding to spoofing. The target image may be processed based on a trained convolutional neural network, where the convolutional neural network may be any end-to-end and point-to-point convolutional neural network, and may be an existing semantic segmentation network, including a semantic segmentation network for full supervision.

In an implementation, the convolutional neural network may be trained by using sample data having pixel-level labels. The trained convolutional neural network may predict, pixel point by pixel point, probabilities of pixel points in an input single image frame corresponding to spoofing.

In some embodiments, the sample data includes: a first type of data and a second type of data, where the first type of data is sample data from spoofing, and the second type of data is non-spoofing data from an image captured from a real person. The sample data is image data, in which each pixel is marked with a label, where the label is a pixel-level label.

The multiple pixel points may be all or some of pixel points of the target image. No limitation is made thereto in the embodiments of the disclosure. The apparatus for liveness detection in the embodiments of the disclosure may recognize pixel points in the target image and predict the probabilities of multiple pixel points of the target image to be corresponding to spoofing. The target image may be an image including a face.

In some embodiments, an input to the apparatus for liveness detection may be the target image including a face, and an output may be the probabilities of multiple pixel points of the target image to be corresponding to spoofing. The probabilities of the multiple pixel points corresponding to spoofing may be in a form of a probability matrix, i.e., a probability matrix of the pixel points of the target image may be obtained. The probability matrix may indicate the probabilities of the multiple pixel points of the target image to be corresponding to spoofing. After obtaining the probabilities of the multiple pixel points of the target image to be corresponding to spoofing, operation 102 may be executed.

At operation 102, a predicted face region in the target image is determined. In some embodiments, a main face region may be determined by means of a face recognition algorithm after detecting a face in the image and positioning key feature points of the face. The face region may be understood as a region where the face is located in the target image.

In the embodiments of the disclosure, the predicted face region in the target image may be determined based on a face key point detection algorithm. In an implementation, face key point detection may be performed on the target image to obtain key point prediction information; and then the predicted face region in the target image may be determined based on the key point prediction information. In some embodiments, key points of the face in the target image may be obtained by means of face key point detection and a convex hull may be calculated, where the convex hull may be used as a rough face region.

In a real vector space V, for a given set X, an intersection S of all convex sets including X is called a convex hull of X. The convex hull of X may be constructed by a convex combination of all points (X1, . . . , Xn) in X. Generally speaking, given a set of points on a two-dimensional plane, the convex hull may be understood as a convex polygon formed by connecting the outermost points, it may include all the points in the set of points, and may be represented as a bounded face region in the target image. The face key point detection algorithm may be any algorithm with several points on a plane as input and the convex hull of the points as output, such as a rotating calipers algorithm, Graham scanning algorithm, and Jarvis operationping algorithm, or include related algorithms in OpenCV.

OpenCV is a cross-platform computer vision library released based on the BSD license (open source), and may run on Linux, Windows, Android and Mac OS operating systems. OpenCV is lightweight and efficient: it is composed of a series of C functions and a small number of C++ classes, it provides interfaces for languages such as Python, Ruby, MATLAB, and implements many general algorithms in image processing and computer vision.

In some embodiments, before performing face key point detection on the target image to obtain the key point prediction information, the method further includes: performing face detection on the target image to obtain a face bounding region in the target image; and performing face key point detection on the target image to obtain the key point prediction information includes: performing face key point detection on the image in the face bounding region to obtain the key point prediction information.

In some face key point detection algorithms, external contours and organs of a face need to be determined. In the embodiments of the disclosure, the accuracy of positioning of the face is high. Therefore, before obtaining the face key points, face detection may be performed at first (relatively high accuracy is required, but any feasible face detection algorithm is acceptable) to obtain a contour bounding box of the face, i.e., the face bounding region; next, the face bounding region is input for face key point detection to obtain the key point prediction information; and then the predicted face region is determined.

In the embodiments of the disclosure, no limitation is made to the number of key points, as long as the contour of the face can be marked.

In some possible implementations, face detection may be performed on the target image to obtain the predicted face region in the target image.

In some embodiments, face detection may be performed based on a face segmentation method to determine the predicted face region in the target image. The accuracy requirement for the face region is not strict in the embodiments of the disclosure; therefore, relevant algorithms that can roughly determine the face region can all be used to determine the predicted face region. No limitation is made thereto in the embodiments of the disclosure.

After obtaining the probabilities of the multiple pixel points of the target image to be corresponding to spoofing and determining the predicted face region in the target image, operation 103 may be executed. At 103, a liveness detection result of the target image is obtained based on the probabilities of the multiple pixel points of the target image to be corresponding to spoofing and the predicted face region.

The authenticity of the face in the target image may be determined by a comprehensive analysis based on the obtained probabilities of the multiple pixel points corresponding to spoofing and the approximate position of the face (the predicted face region) obtained. A probability distribution map may be generated based on the probabilities of the multiple pixel points corresponding to spoofing, where the probability distribution map may be understood as an image that reflects the probabilities of the pixel points of the target image to be corresponding to spoofing, and is intuitive. On this basis, the probabilities of pixel points in the predicted face region corresponding to spoofing may be determined in combination with the predicted face region, thereby facilitating the determination in liveness detection. The pixel points may be determined according to a preset threshold.

In a possible implementation, at least two pixel points included in the predicted face region may be determined from the multiple pixel points based on position information of the multiple pixel points and the predicted face region; and the liveness detection result of the target image is determined based on the probability of each of the at least two pixel points corresponding to spoofing.

In some embodiments, the positions of the pixel points in the target image may be determined. The apparatus for liveness detection may determine the position information of each pixel point, and then determine relative positions of the pixel points and the predicted face region according to the position information of the pixel points and the predicted face region, so as to further determine pixel points in the predicted face region, i.e., determining at least two pixel points included in the predicted face region, which may be denoted as P and may be the total number of pixel points in the predicted face region. The liveness detection result may be determined based on the probability of each of the at least two pixel points corresponding to spoofing. It can be understood that for the pixel points in the predicted face region, the greater the probabilities of the pixel points corresponding to spoofing and the more pixel points having high probabilities, the greater the probability of the liveness detection result being spoofing; conversely, the greater the probability of the liveness detection result being non-spoofing.

Furthermore, determining, based on the probability of each of the at least two pixel points corresponding to spoofing, the liveness detection result of the target image includes: determining, based on the probability of each of the at least two pixel points corresponding to spoofing, at least one spoofing pixel point in the at least two pixel points; and determining, based on a proportion of the at least one spoofing pixel point in the at least two pixel points, the liveness detection result of the target image.

In some embodiments, because the probability of each pixel point of the target image to be corresponding to spoofing is obtained, and at least two pixel points included in the predicted face region are determined, it can be determined that at least one spoofing pixel point in the at least two pixel points is determined based on the probability of each of the at least two pixel points corresponding to spoofing, where the spoofing pixel point may be understood as a pixel point determined to correspond to spoofing.

The determination of the spoofing pixel point may be based on comparison of the probability with a preset threshold. Generally speaking, the higher the proportion of the spoofing pixel point in the pixel points of the predicted face region, the greater the possibility of the liveness detection indicating spoofing.

In some embodiments, a preset threshold λ1 may be stored in the apparatus for liveness detection, and the number of pixel points in the at least two pixel points, of which the probabilities corresponding to spoofing are greater than the preset threshold λ1, may be obtained, i.e., the number of spoofing pixel points, which may be denoted as Q.

After determining the spoofing pixel point, a proportion Q/P of the at least one spoofing pixel point in the at least two pixel points may be calculated, and after determining the proportion, the liveness detection result of the target image may be determined.

In some embodiments, determining, based on the proportion of the at least one spoofing pixel point in the at least two pixel points, the liveness detection result of the target image includes: in response to the proportion being greater than or equal to a first threshold, determining that the liveness detection result of the target image is spoofing.

In some other embodiments, in response to the proportion being less than the first threshold, it is determined that the liveness detection result of the target image is non-spoofing.

In some embodiments, a first threshold λ2 may be set in advance, and the apparatus for liveness detection may store the first threshold λ2 for pixel-by-pixel analysis to perform determination in the liveness detection, that is, whether the face in the target image is spoofing is analyzed by comparing the proportion Q/P with the first threshold λ2. In general, the higher the proportion Q/P, the greater the probability of the spoofing result being spoofing. If the proportion Q/P is greater than or equal to the first threshold λ2, it is determined that the liveness detection result of the target image is spoofing; and if the proportion Q/P is less than the first threshold λ2, it is determined that the liveness detection result of the target image is non-spoofing.

The thresholds used for determination of pixel points in the embodiments of the disclosure may be preset or determined according to actual conditions, and may be modified, added, or deleted. No limitation is made thereto in the embodiments of the disclosure.

In a possible implementation, the liveness detection result of the target image includes whether the face in the target image is non-spoofing or spoofing. After the liveness detection result is obtained, the liveness detection result may be output.

In an implementation, the method further includes: displaying at least one spoofing pixel point determined based on the probabilities of the multiple pixel points corresponding to spoofing.

In an implementation, the method further includes: outputting information of the at least one spoofing pixel point determined based on the probabilities of the multiple pixel points corresponding to spoofing for displaying.

In some embodiments, the apparatus for liveness detection may display the liveness detection result, may display the at least one spoofing pixel point, and may also output the information of the at least one spoofing pixel point determined based on the probabilities of the multiple pixel points corresponding to spoofing, where the information may be used for displaying the spoofing pixel point, i.e., the information may also be transmitted to other terminal devices to display the spoofing pixel point. By displaying or marking the spoofing pixel point, the exact region on which each determination is based in the image may be intuitively seen, so that the detection result has high interpretability.

A person skilled in the art can understand that, in the foregoing method in the specific implementations, the order in which the operations are written does not imply a strict execution order which constitutes any limitation to the implementation process, and the specific order of executing the operations should be determined by functions and possible internal logics thereof.

In the embodiments of the disclosure, a target image may be processed to obtain probabilities of multiple pixel points of the target image to be corresponding to spoofing; a predicted face region in the target image is determined; and a liveness detection result of the target image is then obtained based on the probabilities of the multiple pixel points of the target image to be corresponding to spoofing and the predicted face region. No additional hardware facilities such as a multi-ocular camera or 3D structured light are needed, and the accuracy of liveness detection of a single image frame may also be greatly improved when there is only one monocular camera, thereby achieving high adaptability and reducing detection costs.

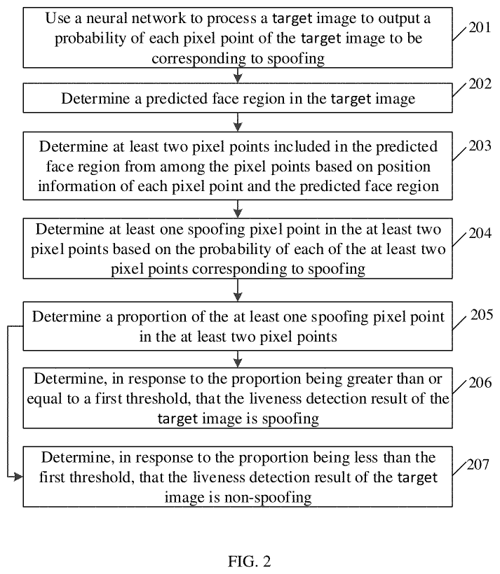

Referring to FIG. 2, FIG. 2 is a schematic flowchart of another method for liveness detection disclosed in embodiments of the disclosure. FIG. 2 is further optimized based on FIG. 1. The subject executing the operations of the embodiments of the disclosure may be the aforementioned apparatus for liveness detection. As shown in FIG. 2, the method for liveness detection includes the following operations. At 201, a neural network is used to process a target image to output a probability of each pixel point of the target image to be corresponding to spoofing.

A trained neural network obtains a probability of each pixel point in a target image to be corresponding to spoofing. In some embodiments, the target image with a size of M×N may be obtained, the target image including a face is processed via the neural network, and an M×N-order probability matrix may be output, where elements in the M×N-order probability matrix may indicate the probabilities of the pixel points of the target image to be corresponding to spoofing, and M and N are integers greater than 1.

A length and width of the image size in the embodiments of the disclosure may be in units of pixels. Pixel and resolution pixel are the most basic units in digital images. Each pixel is a small dot, and dots (pixels) with different colors are aggregated into a picture. Image resolution is an imaging size that many terminal devices may choose, and the unit thereof is dpi. For example, common image resolution includes 640×480, 1024×768, 1600×1200, and 2048×1536. In the two numbers of the imaging size, the former is the width of a picture, and latter is the height of the picture, and the two numbers are multiplied to obtain the pixels of the picture.

The embodiments of the disclosure mainly solve the technical problem of liveness detection for a single image frame. The aforementioned target image may be a single image frame, and may be an image acquired by a camera, such as a photo captured by a camera of a terminal device or a single image frame in a video recorded by a camera of a terminal device.

In some embodiments, before processing the target image, the method further includes: obtaining the target image that is acquired by a monocular camera.

No limitation is made to the acquisition manner of the target image and to specific implementations of examples in the embodiments of the disclosure.

The single image frame mentioned in the embodiments of the disclosure is a still picture. An animation effect, such as a TV video, may be formed by consecutive frames. Generally speaking, the number of frames is simply the number of frames of pictures transmitted in 1 second, may also be understood as the number of times a graphics processing unit can perform refreshing per second, and are usually expressed in fps. Smooth and realistic animation can be obtained with a high frame rate.

In the embodiments of the disclosure, the target image including a face may be processed based on a trained convolutional neural network, where the convolutional neural network may be any end-to-end and point-to-point convolutional neural network, and may be an existing semantic segmentation network, including a semantic segmentation network for full supervision.

In an implementation, the convolutional neural network may be trained by using sample data having pixel-level labels, so that the amount of data required for achieving the same accuracy can be reduced by one or two orders of magnitude, compared with existing methods that use data having image-level labels. The trained convolutional neural network may predict, pixel point by pixel point, probabilities of pixel points in an input single image frame corresponding to spoofing.

An execution subject of the method for liveness detection according to the embodiments of the disclosure may be the apparatus for liveness detection. For example, said method may be performed by a terminal device or a server or other processing devices, where the terminal device may be a UE, a mobile device, a user terminal, a terminal, a cellular phone, a cordless phone, a PDA, a handheld device, a computing device, a vehicle-mounted device, a wearable device, etc. In some possible implementations, the method for liveness detection may be implemented by invoking, by a processor, computer-readable instructions stored in a memory. No limitation is made in the embodiments of the disclosure.

In the embodiments of the disclosure, the apparatus for liveness detection may recognize the image size M×N of the target image, and process the target image including a face by means of a convolutional neural network to predict the probability of each pixel point of the target image to be corresponding to spoofing, which may be output in the form of a corresponding M×N-order probability matrix. It can be understood that elements in the M×N-order probability matrix respectively indicate the probabilities of the pixel points of the target image to be corresponding to spoofing, where M and N are integers greater than 1.

In the embodiments of the present disclosure, a probability distribution map may also be generated based on the convolutional neural network. The probability distribution map may be understood as an image that reflects the probabilities of the pixel points of the target image to be corresponding to spoofing, is relatively intuitive, and also facilitates the determination in liveness detection.

In some embodiments, the convolutional neural network may be obtained by being trained based on a mini-match stochastic gradient descent algorithm and a learning rate decay strategy, which may also be replaced with an optimization algorithm having a similar effect, so as to ensure that a network model can converge during a training process. No limitation is made to the training algorithm in the embodiments of the disclosure.

Gradient descent is one of the iterative methods that can be used to solve least squares problems (both linear and nonlinear). When solving model parameters of a machine learning algorithm, i.e., an unconstrained optimization problem, gradient descent is one of the most commonly used methods. When solving the minimum value of a loss function, a gradient descent method can be used for calculation iteratively operation by operation to obtain a minimized loss function and model parameter values. In machine learning, two gradient descent methods are developed based on the basic gradient descent method, namely, a Stochastic Gradient Descent (SGD) method and a Batch Gradient Descent (BGD) method.

Mini-Batch Gradient Descent (MBGD) in the embodiments of the disclosure is a compromise between BGD and SGD. The idea thereof is to use “batch_size” samples to update the parameters in each iteration. According to the method, optimizing the neural network parameters by means of matrix operation on one batch each time is not much slower than on a single piece of data; moreover, the use of one batch each time can greatly reduce the number of iterations required for convergence, and can also make the convergence result closer to the effect of gradient descent.

Learning rate, as an important parameter in supervised learning and deep learning, determines whether an objective function can converge to a local minimum and when it converges to the minimum. A proper learning rate can make the objective function converge to a local minimum in a suitable time duration.

In an implementation, adjustable parameters in the learning rate decay strategy include an initial learning rate which is set as 0.005 for example, and power of a decay polynomial which is set as, for example, 0.9; and adjustable parameters in the gradient descent algorithm include a momentum set to, for example, 0.5 and a weight attenuation parameter set to, for example, 0.001. The parameters may be set and modified according to actual conditions during training and application. No limitation is made to the specific parameter setting in a training process in the embodiments of the disclosure.

At operation 202, a predicted face region in the target image is determined.

For the operation 202, reference may be made to specific description of operation 102 in the embodiments shown in FIG. 1, and details are not described herein again.

After determining the predicted face region and obtaining the probability of each pixel point of the target image to be corresponding to spoofing, operation 203 may be executed.

At 203, at least two pixel points included in the predicted face region are determined from among the pixel points based on position information of each pixel point and the predicted face region.

In some embodiments, the positions of the pixel points in the target image may be determined. The apparatus for liveness detection may determine the position information of each pixel point, and then determine relative positions of the pixel points and the predicted face region according to the position information of the pixel points and the predicted face region, so as to further determine pixel points in the predicted face region, i.e., determining at least two pixel points included in the predicted face region, where the number thereof may be denoted as P and may be the total number of pixel points in the predicted face region. Then, operation 204 may be executed.

At 204, at least one spoofing pixel point in the at least two pixel points is determined based on the probability of each of the at least two pixel points corresponding to spoofing.

In some embodiments, because the probability of each pixel point of the target image to be corresponding to spoofing is obtained, and at least two pixel points included in the predicted face region are determined, it can be determined that at least one spoofing pixel point in the at least two pixel points is determined based on the probability of each of the at least two pixel points corresponding to spoofing, where the spoofing pixel point may be understood as a pixel point determined to correspond to spoofing.

The determination of the spoofing pixel point may be based on comparison of the probability with a preset threshold. A preset threshold λ1 may be stored in the apparatus for liveness detection, and the number of pixel points in the at least two pixel points, of which the probabilities corresponding to spoofing are greater than the preset threshold λ1, may be obtained, i.e., the number of spoofing pixel points, which may be denoted as Q.

After determining the at least one spoofing pixel point in the at least two pixel points, operation 205 may be executed.

At 205, a proportion of the at least one spoofing pixel point in the at least two pixel points is determined. Furthermore, after determining the spoofing pixel point, a proportion Q/P of the at least one spoofing pixel point in the at least two pixel points may be calculated, i.e., a proportion of the spoofing pixel point in the predicted face region. After determining the proportion, operation 206 and/or operation 207 may be executed.

At 206, it is determined, in response to the proportion being greater than or equal to a first threshold, that the liveness detection result of the target image is spoofing. In the embodiments of the disclosure, a first threshold λ2 may be set in advance, and the apparatus for liveness detection may store the first threshold λ2 for pixel-by-pixel analysis to perform determination in the liveness detection, that is, whether the face in the target image is spoofing is analyzed by determining whether the proportion Q/P is greater than the first threshold λ2. If the proportion Q/P is greater than or equal to the first threshold λ2, it means that the proportion of pixel points determined as spoofing pixel points in the predicted face region is high, and it can be determined that the liveness detection result of the target image is spoofing, and the liveness detection result may be output. If the proportion Q/P is less than the first threshold λ2, it means that the proportion of pixel points determined as spoofing pixel points in the predicted face region is low, and operation 207 may be executed, i.e., determining that the liveness detection result of the target image is non-spoofing.

Furthermore, after determining that the face in the target image is spoofing, alarming information may be output or the alarming information may be sent to a preset terminal device to prompt a user that spoofing is detected in a face recognition process, so as to ensure the security of face recognition.

At 207, it is determined, in response to the proportion being less than the first threshold, that the liveness detection result of the target image is non-spoofing.

In another implementation, the method further includes:

performing averaging processing on the probabilities of the at least two pixel points corresponding to spoofing to obtain an average probability; and

determining, based on the average probability, the liveness detection result of the target image.

In some embodiments, similarly, averaging processing may be performed on the probabilities of the at least two pixel points corresponding to spoofing to obtain an average probability, i.e., an average probability R of the pixel points in the predicted face region corresponding to spoofing.

In some embodiments, a target threshold 23 may be set in advance and stored in the apparatus for liveness detection, and then it can be determined whether the average probability R is greater than the target threshold 23 so as to perform the determination in the liveness detection. If the average probability R is greater than the target threshold 23, it means that the probabilities of the pixel points of the face corresponding to spoofing are relatively high, and it can be determined that the liveness detection result of the target image is spoofing; and if the average probability R is not greater than the target threshold 23, it means that the probabilities of the pixel points of the face corresponding to spoofing are relatively low, and it can be determined that the liveness detection result of the target image is non-spoofing.

In another implementation, obtaining, based on the probabilities of the multiple pixel points of the target image to be corresponding to spoofing and the predicted face region, the liveness detection result of the target image may include: determining, based on the probabilities of the multiple pixel points of the target image to be corresponding to spoofing, a spoofing region of the target image; and determining, based on positions of the spoofing region and the predicted face region, the liveness detection result of the target image.

The spoofing region may be understood as a region where pixel points, the probabilities of which corresponding to spoofing are relatively high, in the target image are gathered. In some embodiments, a second threshold λ4 may be stored in the apparatus for liveness detection; the probabilities of the multiple pixel points corresponding to spoofing may be compared with the second threshold λ4 to determine a region where pixel points having probabilities greater than or equal to the second threshold λ4 are located as a spoofing region. Furthermore, the position of the spoofing region may be compared with that of the predicted face region, and the overlapping condition therebetween may be mainly compared to determine the liveness detection result.

In some embodiments, an overlapping region between the spoofing region and the predicted face region may be determined based on the positions of the spoofing region and the predicted face region; and the liveness detection result of the target image is determined based on a proportion of the overlapping region in the predicted face region.

By comparison of the positions of the spoofing region and the predicted face region, the overlapping region between the spoofing region and the predicted face region may be determined, and then a proportion n of the overlapping region in the predicted face region may be calculated, where the proportion n may be the ratio of the area of the overlapping region to the area of the predicted face region, and the proportion n may be used to determine the liveness detection result of the target image. Generally speaking, the greater the proportion n, the greater the probability of the detection result being spoofing. In some embodiments, a third threshold λ5 may be stored in the apparatus for liveness detection, and the proportion n may be compared with the third threshold λ5. If the proportion n is greater than or equal to the third threshold λ5, it can be determined that the liveness detection result of the target image is spoofing, and if the proportion n is smaller than the third threshold λ5, it can be determined that the liveness detection result of the target image is non-spoofing.

The thresholds used for determination of pixel points in the embodiments of the disclosure may be preset or determined according to actual conditions, and may be modified, added or deleted. No limitation is made thereto in the embodiments of the disclosure.

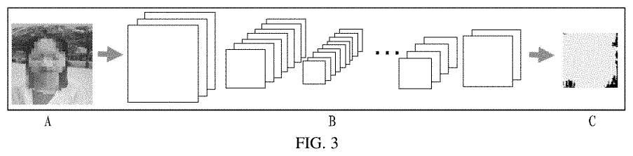

Referring to the schematic diagram of a processing process of a neural network shown in FIG. 3, an image A is the target image, and more specifically, is an image including a face. Liveness detection is required in the process of face recognition. Process B represents the use of a trained neural network to perform convolution processing on the input image A in the embodiments of the disclosure, where the white boxes may be understood as multiple feature maps extracted in a feature extraction process in the convolution layers. For the processing process of the neural network, reference may be made to relevant descriptions in FIGS. 1 and 2, and details are not described herein again. By means of pixel by pixel prediction performed on image A by the neural network, an image C including a predicted face region and a determined probability of each pixel point in the image corresponding to spoofing may be output, i.e., a liveness detection result (spoofing or non-spoofing) may be obtained. If the liveness detection result is spoofing, the predicted face region shown in the image C is a spoofing region (the light-colored region in the middle of the image C), where the included pixel points determined by the probabilities may be referred to as spoofing pixel points, and dark-colored regions at the corners are roughly determined as the background portion of the image and have little influence on the liveness detection. Based on the processing of the input target image by the neural network, the exact region in the image on which the determination is based may also be intuitively seen from the output result, so that the liveness detection result is more interpretable.

A person skilled in the art may understand that, in the foregoing method in the specific implementations, the order in which the operations are written does not imply a strict execution order which constitutes any limitation to the implementation process, and the specific order of executing the operations should be determined by functions and possible internal logics thereof.

The embodiments of the disclosure may be used as a part of a face recognition system to determine the authenticity of a face input to the system, thereby ensuring the security of the entire face recognition system. In some embodiments, the method is applicable to face recognition scenarios such as monitoring systems or attendance checking systems, and compared with a method for directly predicting a probability of whether a face in an image is spoofing, probability analysis based on pixel points improves the accuracy of liveness detection, is applicable to a monocular camera and the detection in a single image frame, has high adaptability, and reduces costs compared with liveness detection using hardware devices such as a multi-ocular camera or 3D structured light. Moreover, the use of sample data having pixel-level labels to train the convolutional neural network can reduce the amount of data required for achieving the same accuracy by one or two orders of magnitude, compared with the general use of data having image-level labels. Thus, the amount of data required for training is reduced while improving the liveness detection accuracy, thereby increasing the processing efficiency.

In the embodiments of the disclosure, a neural network is used to process a target image to output a probability of each pixel point of the target image to be corresponding to spoofing; a predicted face region in the target image is determined; at least two pixel points included in the predicted face region are determined from the pixel points based on position information of each pixel point and the predicted face region; then at least one spoofing pixel point in the at least two pixel points is determined based on the probability of each of the at least two pixel points corresponding to spoofing; next, a proportion of the at least one spoofing pixel point in the at least two pixel points is determined; and it is determined, in response to the proportion being greater than or equal to a first threshold, that the liveness detection result of the target image is spoofing, or it is determined, in response to the proportion being less than the first threshold, that the liveness detection result of the target image is non-spoofing. No additional hardware facilities such as a multi-ocular camera or 3D structured light are needed, and the accuracy of liveness detection of a single image frame may also be greatly improved by means of pixel point-by-pixel point prediction when there is only one monocular camera, thereby achieving high adaptability and reducing detection costs.

The foregoing mainly introduces solutions of the embodiments of the disclosure from the perspective of an execution process in the method side. It can be understood that, in order to achieve the functions, the apparatus for liveness detection includes hardware structures and/or software modules corresponding to the functions. A person skilled in the art may be easily aware that the disclosure may be implemented by hardware, or a combination of hardware and computer software, in combination with the units and operations of algorithms in the examples described in the embodiments disclosed herein. Whether a particular function is executed by hardware or by computer software driving hardware depends on the particular applications and design constraint conditions of the technical solutions. A person skilled in the art may use different methods to implement the described functions for each particular application, but it should not be considered that the implementation goes beyond the scope of the disclosure.

In the embodiments of the disclosure, the apparatus for liveness detection may be divided into functional units according to the method examples. For example, the functional units can be correspondingly divided according to respective functions, or two or more functions are integrated into one processing unit. The integrated unit may be implemented in a form of hardware and may also be implemented in a form of a software functional unit. It should be noted that the division of units in the embodiments of the disclosure is merely exemplary, is merely logical function division, and may be implemented in other division modes in actual implementation.

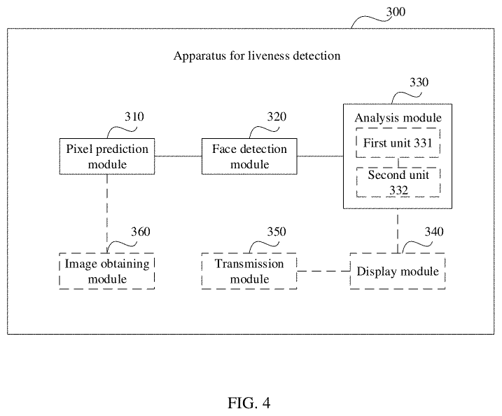

Referring to FIG. 4, FIG. 4 is a schematic structural diagram of an apparatus for liveness detection disclosed in embodiments of the disclosure. As shown in FIG. 4, the apparatus 300 for liveness detection includes a pixel prediction module 310, a face detection module 320, and an analysis module 330, where the pixel prediction module 310 is configured to process a target image to obtain probabilities of multiple pixel points of the target image to be corresponding to spoofing; the face detection module 320 is configured to determine a predicted face region in the target image; and the analysis module 330 is configured to obtain, based on the probabilities of the multiple pixel points of the target image to be corresponding to spoofing and the predicted face region, a liveness detection result of the target image.

In some embodiments, the pixel prediction module 310 is configured to input the target image into a convolutional neural network for processing to obtain a probability of each pixel point of the target image to be corresponding to spoofing.

In some embodiments, the convolutional neural network is obtained by being trained based on sample data having pixel-level labels.

In some embodiments, the analysis module 330 includes a first unit 331 and a second unit 332, where the first unit 331 is configured to determine, based on position information of the multiple pixel points and the predicted face region, at least two pixel points included in the predicted face region from among the multiple pixel points; and the second unit 332 is configured to determine, based on the probability of each of the at least two pixel points corresponding to spoofing, the liveness detection result of the target image.

In some embodiments, the second unit 332 is configured to determine, based on the probability of each of the at least two pixel points corresponding to spoofing, at least one spoofing pixel point in the at least two pixel points; and determine, based on a proportion of the at least one spoofing pixel point in the at least two pixel points, the liveness detection result of the target image.

In an implementation, the second unit 332 is configured to: determine, in response to the proportion being greater than or equal to a first threshold, that the liveness detection result of the target image is spoofing; and/or determine, in response to the proportion being less than the first threshold, that the liveness detection result of the target image is non-spoofing.

In some embodiments, the second unit 332 is configured to: perform averaging processing on the probabilities of the at least two pixel points corresponding to spoofing to obtain an average probability; and determine, based on the average probability, the liveness detection result of the target image.

In an implementation, the analysis module 330 is configured to: determine, based on the probabilities of the multiple pixel points of the target image to be corresponding to spoofing, a spoofing region of the target image; and determine, based on positions of the spoofing region and the predicted face region, the liveness detection result of the target image.

In some embodiments, the analysis module 330 is configured to: determine, based on the positions of the spoofing region and the predicted face region, an overlapping region between the spoofing region and the predicted face region; and determine, based on a proportion of the overlapping region in the predicted face region, the liveness detection result of the target image.

In one possible implementation, the apparatus 300 for liveness detection further includes: a display module 340, configured to display at least one spoofing pixel point determined based on the probabilities of the multiple pixel points corresponding to spoofing; and/or a transmission module 350, configured to output information of the at least one spoofing pixel point determined based on the probabilities of the multiple pixel points corresponding to spoofing for displaying.

In some embodiments, the face detection module 320 is configured to: perform face key point detection on the target image to obtain key point prediction information; and determine, based on the key point prediction information, the predicted face region in the target image.

In some embodiments, the face detection module 320 is further configured to perform face detection on the target image to obtain a face bounding region in the target image; and the face detection module 320 is configured to perform face key point detection on the image in the face bounding region to obtain the key point prediction information.

In an implementation, the face detection module 320 is configured to: perform face detection on the target image to obtain the predicted face region in the target image.

In an implementation, the apparatus 300 for liveness detection further includes an image obtaining module 360 configured to obtain the target image that is acquired by a monocular camera.

The method for liveness detection in the embodiments in FIGS. 1 and 2 can be implemented by using the apparatus 300 for liveness detection in the embodiments of the disclosure.

For the apparatus 300 for liveness detection as shown in the embodiments of FIG. 4, the apparatus 300 for liveness detection may process a target image to obtain probabilities of multiple pixel points of the target image to be corresponding to spoofing, determine a predicted face region in the target image, and then obtain, based on the probabilities of the multiple pixel points of the target image to be corresponding to spoofing and the predicted face region, a liveness detection result of the target image. No additional hardware facilities such as a multi-ocular camera or 3D structured light are needed, and the accuracy of liveness detection of a single image frame may also be greatly improved when there is only one monocular camera, thereby achieving high adaptability and reducing detection costs.

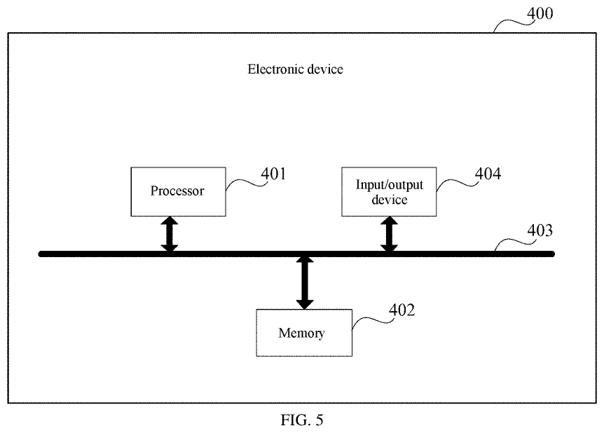

Referring to FIG. 5, FIG. 5 is a schematic structural diagram of an electronic device disclosed in embodiments of the disclosure. As shown in FIG. 5, the electronic device 400 includes a processor 401 and a memory 402, the electronic device 400 may further include a bus 403, the processor 401 may be connected to the memory 402 by means of the bus 403, and the bus 403 may be a Peripheral Component Interconnect (PCI) bus, an Extended Industry Standard Architecture (EISA) bus, etc. The bus 403 may include an address bus, a data bus, a control bus, etc. For ease of representation, only one thick line is used in FIG. 4, but it does not mean that there is only one bus or one type of bus. The electronic device 400 may further include an input/output device 404, which may include a display screen, such as a liquid crystal display screen. The memory 402 is configured to store a computer program; the processor 401 is configured to invoke the computer program stored in the memory 402 to execute some or all of the operations of the method mentioned in the embodiments of FIG. 1 and FIG. 2 above.

For the electronic device 400 as shown in the embodiments of FIG. 5, the electronic device 400 may process a target image to obtain probabilities of multiple pixel points of the target image to be corresponding to spoofing, determine a predicted face region in the target image, and then obtain, based on the probabilities of the multiple pixel points of the target image to be corresponding to spoofing and the predicted face region, a liveness detection result of the target image. No additional hardware facilities such as a multi-ocular camera or 3D structured light are needed, and the accuracy of liveness detection of a single image frame may also be greatly improved when there is only one monocular camera, thereby achieving high adaptability and reducing detection costs.

Embodiments of the disclosure further provides a computer storage medium, where the computer storage medium is configured to store a computer program, and the computer program enables a computer to execute some or all of the operations of the method for liveness detection described in any one of the foregoing method embodiments.

Embodiments of the disclosure provide a computer program product, where the computer program product includes a computer program, the computer program is configured to be executed by a processor, and the processor is configured to execute some or all of the operations of the method for liveness detection described in any one of the foregoing method embodiments.

Is should be noted that, to simplify the descriptions, the foregoing method embodiments are expressed in a series of action combinations. However, a person skilled in the art should know that the disclosure is not limited by the described sequence of actions, because according to the disclosure, some operations can be performed in other orders or simultaneously. In addition, a person skilled in the art should also be aware that the embodiments described in the description are all preferred embodiments, and the actions and modules involved therein are not necessarily required in the disclosure.

In the aforementioned embodiments, description of the embodiments all have their own focuses, and for portions that are not described in detail in a particular embodiment, reference can be made to the related description in other embodiments.

It should be understood that the disclosed apparatus in several embodiments provided in the disclosure may be implemented in other modes. For example, the apparatus embodiments described above are merely exemplary. For example, the division of the units is merely logical function division and may be implemented in other division modes in actual implementation. For example, a plurality of units or components may be combined or integrated into another system, or some features may be ignored or not executed. In addition, the displayed or discussed mutual couplings or direct couplings or communication connections may be implemented by means of some interfaces. The indirect couplings or communication connections between the apparatuses or units may be electrical or in other forms.

The units (modules) described as separate parts may or may not be physically separate, and the parts displayed as units may or may not be physical units, may be located at one position, or may be distributed on a plurality of network units. Some of or all of the units may be selected according to actual needs to achieve the objectives of the solutions of the embodiments.

In addition, functional units in the embodiments of the disclosure may be integrated into one processing unit, or each of the units may exist alone physically, or two or more units may be integrated into one unit. The integrated unit may be implemented in a form of hardware and may also be implemented in a form of a software functional unit.

When being implemented in a form of a software functional unit and sold or used as an independent product, the integrated unit may be stored in a computer-readable memory. Based on such an understanding, the technical solutions of the disclosure or a part thereof contributing to the prior art may be essentially embodied in the form of a software product. The computer software product is stored in one memory and includes several instructions so that one computer device (which may be a personal computer, a server, a network device, or the like) implements all or some of the operations of the method in the embodiments of the disclosure. Moreover, the foregoing memory includes: various media capable of storing a program code, such as a USB flash drive, a Read-only Memory (ROM), a Random Access Memory (RAM), a mobile hard disk drive, a floppy disk, or an optical disc.

A person skilled in the art can understand that all or some of the operations in the method in the embodiments may be completed by a program instructing relevant hardware, where the program may be stored in a computer-readable memory, and the memory may include a flash drive, a ROM, a RAM, a floppy disk, or an optical disc, etc.

The embodiments of the disclosure are described in detail above, and specific examples are used herein to explain principles and implementations of the disclosure. The descriptions of the embodiments are only used to help understand the method and the core idea of the disclosure. In addition, for a person skilled in the art, according to the idea of the disclosure, changes may be made in the specific implementations and application scope. In conclusion, the content of the present description should not be understood as to limit the disclosure.

1. A method for liveness detection, comprising:
processing a target image to obtain probabilities of multiple pixel points of the target image to be corresponding to spoofing;
determining a predicted face region in the target image; and
obtaining, based on the probabilities of the multiple pixel points of the target image to be corresponding to spoofing and the predicted face region, a liveness detection result of the target image.

2. The method for liveness detection according to claim 1, wherein processing the target image to obtain the probabilities of the multiple pixel points of the target image to be corresponding to spoofing comprises:
using a neural network to process the target image to output the probability of each pixel point of the target image to be corresponding to spoofing.

3. The method for liveness detection according to claim 2, wherein the neural network is obtained by being trained based on sample data having pixel-level labels.

4. The method for liveness detection according to claim 1, wherein obtaining, based on the probabilities of the multiple pixel points of the target image to be corresponding to spoofing and the predicted face region, the liveness detection result of the target image comprises:
determining, based on position information of the multiple pixel points and the predicted face region, at least two pixel points comprised in the predicted face region from among the multiple pixel points; and
determining, based on the probability of each of the at least two pixel points corresponding to spoofing, the liveness detection result of the target image.

5. The method for liveness detection according to claim 4, wherein determining, based on the probability of each of the at least two pixel points corresponding to spoofing, the liveness detection result of the target image comprises:
determining, based on the probability of each of the at least two pixel points corresponding to spoofing, at least one spoofing pixel point in the at least two pixel points; and
determining, based on a proportion of the at least one spoofing pixel point in the at least two pixel points, the liveness detection result of the target image.

6. The method for liveness detection according to claim 5, wherein determining, based on the proportion of the at least one spoofing pixel point in the at least two pixel points, the liveness detection result of the target image comprises:
in response to the proportion being greater than or equal to a first threshold, determining that the liveness detection result of the target image is spoofing; and/or
in response to the proportion being less than the first threshold, determining that the liveness detection result of the target image is non-spoofing.

7. The method for liveness detection according to claim 4, wherein determining, based on the probability of each of the at least two pixel points corresponding to spoofing, the liveness detection result of the target image comprises:
performing averaging processing on the probabilities of the at least two pixel points corresponding to spoofing to obtain an average probability; and
determining, based on the average probability, the liveness detection result of the target image.

8. The method for liveness detection according to claim 1, wherein obtaining, based on the probabilities of the multiple pixel points of the target image to be corresponding to spoofing and the predicted face region, the liveness detection result of the target image comprises:
determining, based on the probabilities of the multiple pixel points of the target image to be corresponding to spoofing, a spoofing region of the target image; and
determining, based on positions of the spoofing region and the predicted face region, the liveness detection result of the target image.

9. The method for liveness detection according to claim 8, wherein determining, based on the positions of the spoofing region and the predicted face region, the liveness detection result of the target image comprises:
determining, based on the positions of the spoofing region and the predicted face region, an overlapping region between the spoofing region and the predicted face region; and
determining, based on a proportion of the overlapping region in the predicted face region, the liveness detection result of the target image.

10. The method for liveness detection according to claim 9, further comprising:
displaying at least one spoofing pixel point determined based on the probabilities of the multiple pixel points corresponding to spoofing; and/or
outputting information of the at least one spoofing pixel point determined based on the probabilities of the multiple pixel points corresponding to spoofing for displaying.

11. The method for liveness detection according to claim 1, wherein determining the predicted face region in the target image comprises:
performing face key point detection on the target image to obtain key point prediction information; and
determining, based on the key point prediction information, the predicted face region in the target image.

12. The method for liveness detection according to claim 11, wherein before performing face key point detection on the target image to obtain key point prediction information, the method further comprises:
performing face detection on the target image to obtain a face bounding region in the target image,
wherein performing face key point detection on the target image to obtain the key point prediction information comprises:
performing face key point detection on the target image in the face bounding region to obtain the key point prediction information.

13. The method for liveness detection according to claim 1, wherein determining the predicted face region in the target image comprises:
performing face detection on the target image to obtain the predicted face region in the target image.

14. The method for liveness detection according to claim 1, wherein before processing the target image, the method further comprises:
obtaining the target image that is acquired by a monocular camera.

15. An apparatus for liveness detection, comprising:
a memory storing processor-executable instructions; and
a processor arranged to execute the stored processor-executable instructions to perform operations of:
processing a target image to obtain probabilities of multiple pixel points of the target image to be corresponding to spoofing;
determining a predicted face region in the target image; and
obtaining, based on the probabilities of the multiple pixel points of the target image to be corresponding to spoofing and the predicted face region, a liveness detection result of the target image.

16. The apparatus for liveness detection according to claim 15, wherein processing the target image to obtain the probabilities of the multiple pixel points of the target image to be corresponding to spoofing comprises:
using a neural network to process the target image to output the probability of each pixel point of the target image to be corresponding to spoofing.

17. The apparatus for liveness detection according to claim 16, wherein the neural network is obtained by being trained based on sample data having pixel-level labels.

18. The apparatus for liveness detection according to claim 15, wherein obtaining, based on the probabilities of the multiple pixel points of the target image to be corresponding to spoofing and the predicted face region, the liveness detection result of the target image comprises:
determining, based on position information of the multiple pixel points and the predicted face region, at least two pixel points comprised in the predicted face region from among the multiple pixel points; and
determining, based on the probability of each of the at least two pixel points corresponding to spoofing, the liveness detection result of the target image.

19. The apparatus for liveness detection according to claim 18, wherein determining, based on the probability of each of the at least two pixel points corresponding to spoofing, the liveness detection result of the target image comprises:
determining, based on the probability of each of the at least two pixel points corresponding to spoofing, at least one spoofing pixel point in the at least two pixel points; and
determining, based on a proportion of the at least one spoofing pixel point in the at least two pixel points, the liveness detection result of the target image.

20. A non-transitory computer-readable storage medium, having stored thereon computer program instructions that, when executed by a computer, cause the computer to perform the following:
processing a target image to obtain probabilities of multiple pixel points of the target image to be corresponding to spoofing;
determining a predicted face region in the target image; and
obtaining, based on the probabilities of the multiple pixel points of the target image to be corresponding to spoofing and the predicted face region, a liveness detection result of the target image.
